(19) United States
(12) Patent Application Publication
(10) Pub. No.: US 2009/0128346 A1
(43) Pub. Date: May 21, 2009

(54) ALERT DEVICES AND METHODS FOR PORTABLE ELECTRONIC DEVICE REMOVAL FROM CHARGERS

(75) Inventors: Hong Zhao, Naperville, IL (US); Christian Flowers, Chicago, IL (US); Dean Thorson, Grayslake, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Libertyville, IL (US)

(21) Appl. No.: 11/943,133

(22) Filed: Nov. 20, 2007

(51) Int. Cl. G08B 21/00

(52) U.S. Cl. 340/636.15

(57) ABSTRACT

Disclosed are devices and methods of electronic devices for activating an alarm when it is detected that an applied charging voltage has dropped below a threshold value. An electronic device is configured to detect the type of charger, for example, a bicycle charger or motorcycle charger, connected to the electronic device according to a charger attribute. The electronic device may further detect when the applied charging voltage has decreased below the predetermined threshold value. When the device is detected to be connected to a particular type of charger, and it is detected that the applied charging voltage has decreased below the threshold value, the alarm may be activated after a predetermined time. In this way, a user of a bicycle charger or other vehicle charger can be reminded to remove the electronic device from the charging cradle of the vehicle, helping to avoid loss or theft of the device.

### FIELD

Described are devices and methods of an electronic device for charging of a device, and more particularly devices and methods of an electronic device for providing an alert to remove the device from a charger when charging has diminished or ceased.

### BACKGROUND

Mobile communication devices continue to gain popularity in emerging markets, since mobile communication systems have the advantage of less required infrastructure than hard-wired systems. Therefore, many emerging market regions are opting for the installation of mobile communication systems and their residents are becoming mobile communication subscribers. Sales of cell phones and other portable electronic devices are expected to continue to rise in emerging market regions.

In many emerging market regions, electrical utility infrastructures are minimally developed making charging of mobile communication devices often times difficult. Electricity may be provided for only a few hours per day, for example, during the middle of the night. In other cases, generators or other sources of electricity may provide electricity to residents of emerging market regions in limited amounts. Furthermore, in homes or businesses, electrical outlets may be few. Therefore, it may be difficult for residents of emerging market regions who share electrical facilities to recharge their mobile communication devices or other portable electronic devices from an electric utility infrastructure.

Bicycles, motorcycles, other vehicles, or other equipment may be adapted to include a charger to charge a portable device, particularly in emerging market regions where regular electric utility power may not be available. An owner or user of a bicycle or motorcycle adapted with a device charger may place a mobile communication device in a charging cradle utilizing pedaling, vehicle motion, or motor power so that the device may charge while the bicycle or motorcycle is in use. However, when the pedaling, vehicle motion, or motor power ceases, it can be easy to forget that the mobile communication device or other portable electronic device is in the charging cradle. A user may simply walk away leaving the mobile communication device in the charging cradle. Unfortunately, it is therefore possible that the device may become lost or stolen. Loss of the device can be a major issue because the cost of, for example, a cell phone can be well over a month's salary of a regular worker in an emerging market region.

### BRIEF DESCRIPTION OF THE DRAWINGS

FIG. 1 shows an electronic device having an alert to notify a user when a charger ceases charging according to an embodiment; and

FIG. 2 shows an embodiment of a method of an electronic device for generating an alert when the device ceases charging, that may remind a user to remove the device from a charger.

### DETAILED DESCRIPTION

It would be beneficial that a portable electronic device have an alarm so that a user can be reminded to remove the portable electronic device from a charger or charging cradle when charging voltage to the device drops, for example, when a bicycle stops moving or when a motorcycle's electrical system is switched off. It would further be beneficial that a portable electronic device with an alarm recognize the type of charger connected, so that false alarms aren't raised, for example, during a power outage while the device is connected to a device charger for household use. It would in addition be beneficial if a portable electronic device configured with a charger alarm, and configured to recognize the type of charger connected, were adapted for use with a bicycle charging cradle or a charging cradle for use with another type of vehicle, during use of the bicycle or other vehicle for transportation.

Disclosed are devices and methods of electronic devices for activating an alarm when it is detected that an applied charging voltage has dropped below a threshold value. In an embodiment, an electronic device is configured to detect the type of charger connected to the electronic device according to a charger attribute, for example, a bicycle charger. The electronic device may further detect when the applied charging voltage has decreased below the predetermined threshold value. When the device is detected to be connected to a particular type of charger, and it is detected that the applied charging voltage has decreased below the threshold value, the alarm may be activated after a predetermined time. In this way, a user of a bicycle charger or other vehicle charger can be reminded to remove the electronic device from the charging cradle of the vehicle, helping to avoid loss or theft of the device.

As mentioned, the device is configured to detect and identify a charger type based on detection of a predetermined charger attribute. In another disclosed embodiment, the alarm may initially produce an alarm at a first predetermined level, and after a predetermined time may elevate the alarm to a second predetermined level. Such a change in the volume or characteristic of the alarm may alert a user as the user is walking away from the bicycle or motorcycle, the distance between them increasing. Also, the electronic device may be configured to accept user input to temporarily silence the alarm or otherwise configure the alarm, which may be useful if the user has not left the bicycle or motorcycle. In this manner the electronic device may provide a reminder to remove the device from a charger or charging cradle of, for example, a bicycle or motorcycle, when the user accidentally leaves the device in the charging cradle, thereby reducing the chance that the device may be forgotten in the charging cradle when the bicycle or motorcycle is stopped.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Some of the functionality related to the various embodiments disclosed herein may require software programs or instructions and integrated circuits (ICs) such as application specific ICs, and may require coordination with other various software programs or instructions operational within a mobile communication device for example, for displaying indicia or content on one or more displays operating in a manner corresponding to the position of the housings. It is expected that one of ordinary skill, when guided by the concepts and principles disclosed herein will be readily capable of generating such software instructions and programs and/or ICs with minimal experimentation. Therefore, in the interest of brevity and minimization of any risk of obscuring the principles and concepts according to the various embodiments herein disclosed, further discussion of such software and ICs, if any, will be limited to the essentials sufficient to facilitate understanding by one of ordinary skill.

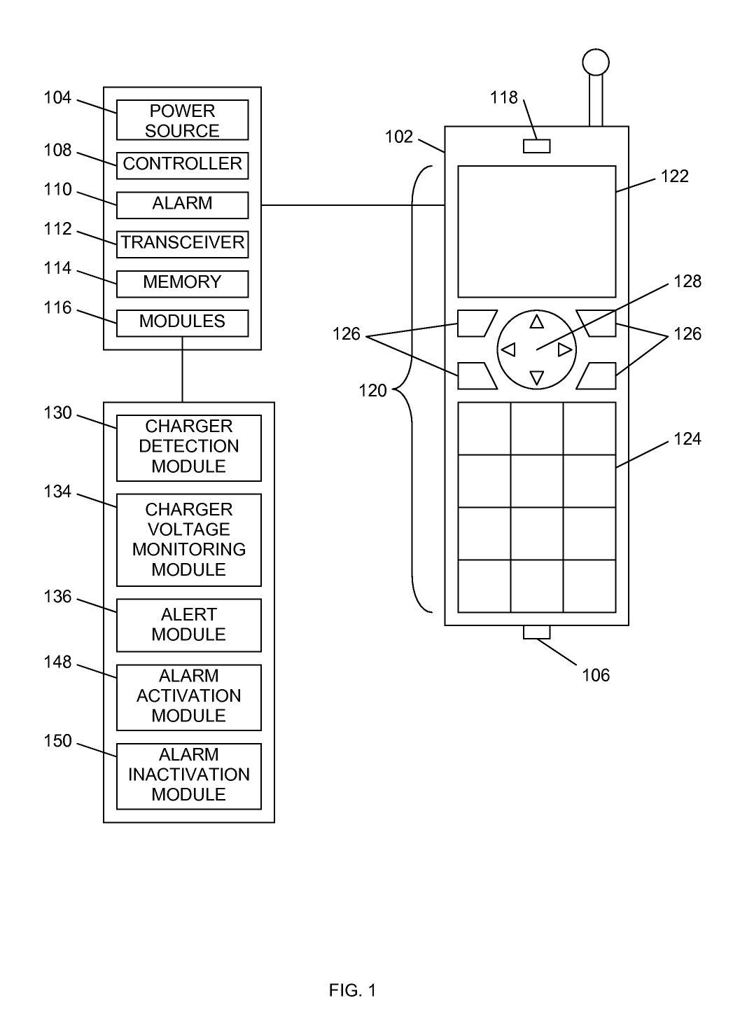

FIG. 1 shows an electronic device 102 having an alert to notify a user when a charger ceases charging according to an embodiment. In the example, the charger is configured to receive power from a moving vehicle such as a bicycle or motorcycle. The device 102 may be for example a portable electronic device such as a mobile communication device. The device 102 includes a power source 104 that typically includes one or more rechargeable cells. The electronic device 102 may be configured to be connected to a charger via a charging port 106 that may provide a charging current from a charger to the power source 104. The electronic device 102 may further include a controller 108 configured to execute instructions and an alarm 110 coupled to the controller. The alarm 1 10 as will be discussed in more detail below is configured to sound and/or flash when there is a substantial drop in the charging current to the power source 104, or in the charging voltage applied to the power source, thus notifying a user that the device is still in the charger even though the bicycle or other vehicle has ceased moving. In this way a user may be less likely to leave behind in a charger a device that thereby may be lost or stolen.

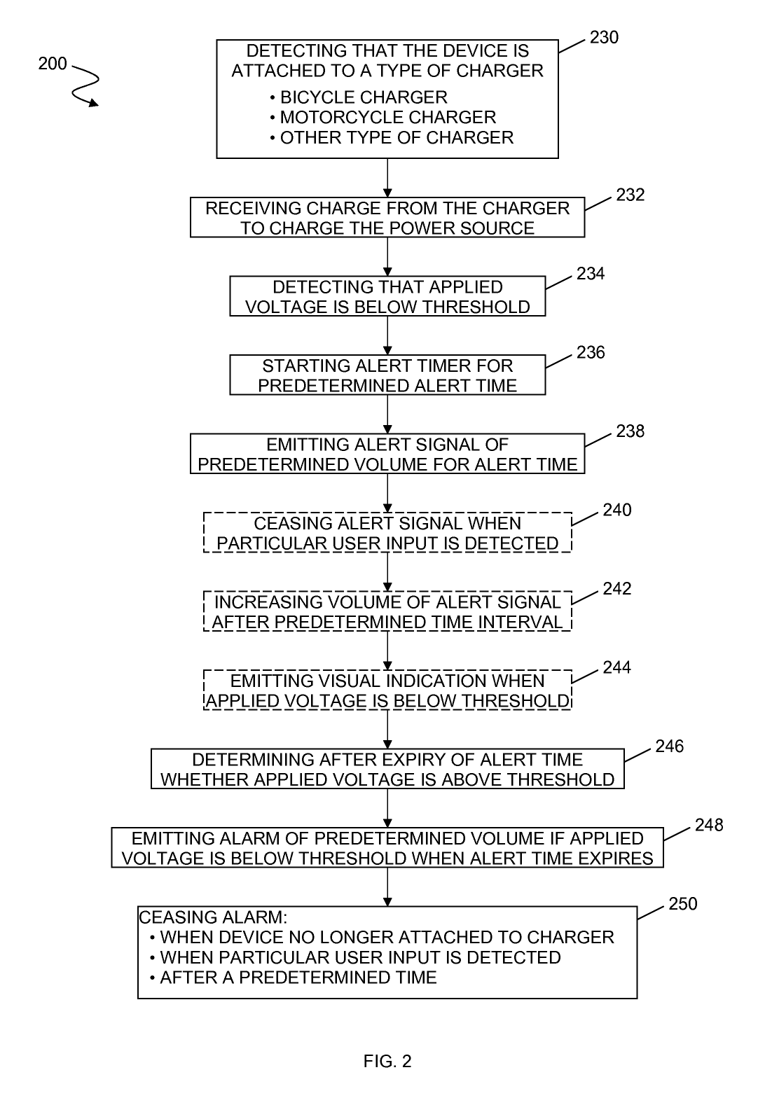

The controller 108 is coupled to the power source 104 and configured to initiate charging of the power source when the electronic device 102 is connected to a charger via the charging port 106, for example, when the user begins pedaling a bicycle to which the charger is mounted. When pedaling ceases and/or if vehicle motion stops, the controller 108 is further configured to activate the alarm 110 when it is detected that an applied charging voltage from the charging port 106 has dropped below a predetermined threshold value, discussed below in connection with FIG. 2. In this manner the electronic device 102 may provide a reminder to remove the device from a charger or charging cradle of, for example, a bicycle or motorcycle, thereby reducing the chance that the device 102 may be forgotten in the charging cradle when the bicycle or motorcycle is stopped.

More particularly, in a bicycle charger, a generator may produce a charging current that can be received by the charging port 106, while the bicycle is in motion. When the bicycle rider stops, for example at a traffic signal or upon reaching the bicycle rider's destination, the charging current may no longer be produced, and there is no longer an applied voltage from the charging port to drive recharging of the power source 104 (see FIG. 1). In a motorcycle charger, the charging port may receive a charging current from the electrical system of the motorcycle. Consequently, when the motorcycle is turned off, for example, upon reaching the motorcycle rider's destination, the charging current may no longer be available. In this circumstance too, there is no longer an applied voltage from the charging port to drive recharging of the power source 104. It is understood that connection to another type of charger other than a bicycle charger and a motorcycle charger is within the scope of this disclosure.

The device 102 may detect (230, see FIG. 2) attachment via the charging port 106 to a predetermined type of charger. In this way, the device activates the presently-discussed alert device and method. That is, in a different situation, if the device were charged via an electrical outlet, it may not be useful for an alarm to sound when charging ceases or is substantially reduced. Accordingly, the type of charger may be identified by an attribute of the charger. For example, the device 102 may be attached to a bicycle charger, a motorcycle charger, or another type of charger. The charger, for example, may include an ID resistor that may be sensed by the device 102 through the charging port 106 that is coupled to the controller 108 to identify the charger. In another embodiment, the charger may include a capacitor, inductor, integrated circuit, or another component that provides an attribute by which the device 102 may sense the type of charger. In this manner the charging port 106 is configured to be identifiably coupled to a predetermined type of charger. It is understood that the charging port 106 may provide a wired connection between the electronic device 102 and a charger. It is further understood that the charging port 106 may provide a contactless charging connection, for example, for inductive charging, between the electronic device 102 and a charger. In this way the charging port 106 may receive charge to provide a charging current, in order to recharge the power source 104 of the mobile communication device 102, and the type of charger may be identified.

While the above discussion is with reference to a mobile communication device, it is understood that any type of device may be charged and include the described alarm in accordance with this discussion. The mobile communication device 102 may be implemented as a cellular telephone (also called a mobile phone). The mobile communication device 102 represents a wide variety of devices that have been developed for use within various communication networks. Such handheld communication devices include, for example, cellular telephones, messaging devices, personal digital assistants (PDAs), notebook or laptop computers, mobile data terminals, application specific gaming devices, video gaming devices, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The mobile communication device or portable electronic device 102 may include other components such as a transceiver 112, a memory 114, and modules 1 16. The transceiver 112 may be coupled to the controller 108 and may provide for wireless communication with one or more additional wireless devices. The memory 114 is coupled to the controller and configured to store instruction modules 1 16. Moreover, it is understood that some modules 116 may be implemented in hardware, or include hardware components.

The modules 116 can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The methods, processes, and operations in accordance with the modules are discussed in more detail below.

The modules 116 may include a charger detection module 130 configured to detect that the electronic device 102 is connected to a type of charger, a charger voltage monitoring module 134 configured to monitor an applied charging voltage from the charging port 106, and an alert module 136. The alert module 136 is configured to initiate an alert signal if the applied charging voltage drops below a predetermined threshold, and to continue the alert signal for a predetermined alert time. The modules 116 may also include an alarm activation module 148 configured to activate an alarm if the applied charging voltage is below the threshold when the predetermined alert time expires, and an alarm inactivation module 150 configured to inactivate the alarm when particular conditions are met. The modules are discussed below in connection with FIG. 2.

To sound the above-described alarm, the device 102 may in addition include an audio transducer 118 coupled to the controller and configured to emit an alert signal having a volume below a first predetermined volume and configured to emit an alarm having a volume above a second predetermined volume. An alert signal at a first predetermined volume that is, for example, a low volume, can be effective when traffic is stopped, for example, at a traffic signal. The alert signal serves to alert the rider, in this example, of a bicycle, that the device 102 is in the charging cradle of the bicycle, and is not receiving a charge.

The first predetermined volume may be sufficiently high to be heard above customary traffic or street noise. Bicycle riders who typically ride at night or in quieter locales may wish to reduce the first predetermined volume. Accordingly, the first predetermined volume may be configurable via, for example, a user interface, discussed below. The second predetermined volume may be typically higher than the first predetermined volume. The second predetermined volume may serve to notify the rider to remove the device from the charger once the vehicle is stopped. In this manner, a user may be reminded to remove the portable electronic device from a charger or charging cradle when charging voltage to the device drops, for example, when a bicycle stops moving or when a motorcycle's electrical system is switched off. The reminder to remove the device from the vehicle charger may avoid loss or theft of the device were the user to forget to remove the device.

The mobile communication device 102 may include user interface devices such as a display 122, and may in addition include a keypad 124. The user interface device or devices may be used to enter user input in order to silence an alert signal or alarm. The display 122 and the keypad 124 may together make up a user interface 120. The user interface 120 may include other elements. For example, the display 122 may also include touch screen capability. The user interface may include, for example, soft keys 126 and/or a navigation circle 128. As discussed above, the first predetermined volume, that is, the volume level of the alert signal, may be configured via the user interface 120, for example, via the navigation circle 128. In addition, the alert signal or alarm may be turned off for a time via user input, for example, via use of a soft key 126 or a key of the keypad 124. It is understood that any manner of user input via the user interface 120 to configure or turn off the alert signal or alarm is within the scope of this discussion. In this way, a user may be alerted that a device is in a charging cradle of a motorcycle or bicycle, and the user may temporarily silence the alert signal or alarm when it is not needed.

FIG. 2 shows an embodiment of a method 200 of an electronic device 102 (see FIG. 1) for generating an alert when the device ceases charging, that may remind a user to remove the device from a charger. The electronic device 102 has a power source 104 that may be recharged when the device is connected to a charger. In the described method, the device may detect when it is connected to a charger that may be of a particular type. In this way, the device activates the presently-discussed alert device and method. That is, in a different situation, if the device were charged via an electrical outlet, it may not be useful for an alarm to sound when charging ceases or is substantially reduced, and identifying the particular type of charger can avoid sounding an alarm that may not be useful. When it is detected by the device that the applied charging voltage has decreased below the threshold value, the alarm may be activated after a predetermined time. In this way, a rider of, for example, a bicycle equipped with a charging cradle may be reminded to remove the electronic device 102 from the charging cradle when the bicycle has stopped moving, thereby helping to avoid loss or theft of the electronic device 102.

As mentioned above, the device 102 (see FIG. 1) detects 230 that it is attached to a particular predetermined type of charger via the charging port 106. The type of charger may be, for example, a bicycle charger or a motorcycle charger. The charger may therefore be an identifiable type of charger. The type of charger may be identified, as discussed above, by an attribute of the charger, for example, a charger ID resistor that may be sensed by the device through the charging port. Detecting that the device 102 is connected to a charger takes place according to the charger module 130, which has instructions configured to detect and identify when the device 102 is coupled to the predetermined type of charger.

Once connected to a charger via the charging port 106 (see FIG. 1), the device 102 may receive charge 232 from the charger to recharge the power source 104. The charging port 106 may provide the charge to recharge the power source 104 at an applied voltage. Typically, an applied voltage for charging a rechargeable battery should be above a predetermined applied voltage threshold level. The predetermined applied voltage threshold may be, for example, 4.5 V, but the value depends on the type and voltage of the power source 104. Receiving charge 232 may take place via the charging port 106, and may occur according to the charger voltage monitoring module 134, which has instructions configured to monitor whether an applied voltage of the received charge is below a predetermined threshold value. Accordingly, the charger voltage monitoring module 134 may detect 234 if an applied voltage of the received charge is below the predetermined threshold value. In such a case, a bicyclist may have ceased pedaling the bicycle and/or the bicycle's motion may have stopped and therefore the charger would cease charging the device.

When charger voltage monitoring module 134 (see FIG. 1) detects 234 that the applied charging voltage is below the predetermined threshold value, an alert timer may be started 236. The alert timer may be configured to run for a predetermined alert time, for example, for 30 seconds, 60 seconds, 90 seconds, or another alert time. The length of the alert time may depend on, for example, local traffic signal durations. The length of the alert time may in addition be configurable by a user, for example, via the user interface 120. Starting of the alert timer may occur in accordance with alert module 136.

The alert module 136 (see FIG. 1) may in addition initiate emitting 238 of an alert signal. The alert signal commences at a predetermined first volume level, as discussed above. The alert signal may endure for the predetermined alert time discussed above. A bicycle rider, motorcycle rider, or other user can optionally turn the alert signal off, that is, the alert signal may cease 240 when particular user input is detected. In another embodiment, the volume of the alert signal may increase 242 during its emission. The increase may occur after a predetermined time interval, for example, 10 seconds, or it may occur in a continuous manner. The increase may in an embodiment occur in a series of steps. It is understood that any manner of increasing the volume of the alert signal is within the scope of this disclosure.

In some situations or localities, it may be difficult to hear an alert signal. In other circumstances it may be undesirable to emit an audible alert signal. Accordingly, the alert signal may be an audible signal or it may be a visual signal, or both. Any type of alert is within the scope of this discussion. An audible signal may be emitted via, for example, the audio transducer 118 (see FIG. 1). A visual signal may include, that, for example, the display 122 of the device 102 may flash or show a distinctive pattern, or both. The method 200 may therefore include emitting 244 a visual indication when the applied charging voltage is below the predetermined threshold. Accordingly, the device 102 may include a visible alarm coupled to the controller and configured to emit a visual indication when the charger detection module 130 detects a type of charger and the charger voltage monitoring module 134 detects that the applied charging voltage is below the predetermined threshold value. Whether the alert signal is emitted audibly, visually, or both may be configurable via the user interface 120.

When certain conditions are met, the alert signal may cease. One condition, just discussed, is that a rider or user supply user input to turn off the alert signal. Another condition is if the applied charging voltage is determined to again be above the threshold value in accordance with the charger voltage monitoring module 134 (see FIG. 1). In an embodiment, determining 246 whether the applied charging voltage is above the predetermined threshold may take place after expiration of the alert time. The conditions also include that the device is no longer attached to the charger. Finally, if the device is still attached to the charger, the applied charging voltage is still below threshold, and the alert time has expired, then the alert signal ceases, to be replaced by emission 148 of an alarm, in accordance with alarm activation module 148. The alarm activation module 148 has instructions configured to transmit a signal to the audio transducer 118 to emit an alarm having a volume above a second predetermined volume after the predetermined alert time has expired, when the charger detection module 130 detects and identifies the predetermined type of charger and the charger voltage monitoring module 134 detects that the applied charging voltage is below the predetermined threshold value. In this manner a user may be notified to remove the device from the charger or charging cradle when the charging port 106 no longer supplies charge at an applied voltage above the predetermined voltage threshold.

The alarm may cease 250 when particular conditions are detected. The conditions may include that a rider or user supply user input to turn off the alarm. Another condition may be that a predetermined time has elapsed. The conditions also include that the device is no longer attached to the charger. The alarm activation module 148 may be configured to cease activation of the alarm when particular user input to the user input device is detected, or after a predetermined time. In an embodiment, the alarm activation module 148 may be configured to cease activation of the alarm only after the user has entered a personal identification number (PIN) or other predetermined security code. In this way, if the device is removed by a thief, the alarm will continue to sound until the power is depleted. In the same embodiment or another embodiment, inactivation of the alarm may take place according to alarm inactivation module 150, which has instructions configured to extinguish the alarm for example, when the charger detection module 130 no longer detects a type of charger. In an embodiment, the alarm inactivation module 150 may require the user to enter a PIN or other predetermined security code, so that if the device is removed by a thief, the alarm will continue to sound until the power is depleted. In this manner a user may be reminded to remove a device from a bicycle charger, motorcycle charger, or other type of charger upon arrival at the user's destination.

Disclosed above are portable electronic devices that have an alarm so that a user can be reminded to remove the portable electronic device from a charger or charging cradle when charging voltage to the device drops, for example, when a bicycle stops moving or when a motorcycle's electrical system is switched off. The alarm may be activated when the electronic device detects that an applied charging voltage has dropped below a threshold value. The electronic device includes a charger detection module configured to detect the type of charger connected to the electronic device. A charger voltage monitoring module is configured to detect when the applied charging voltage has decreased below the predetermined threshold value. When the device is detected to be connected to a particular type of charger, and it is detected that the applied charging voltage has decreased below the threshold value, the alarm may be activated after a predetermined time. The electronic device may in addition be configured to accept user input to temporarily silence the alarm or otherwise configure the alarm. In this manner the electronic device may provide a reminder to remove the device from a charger or charging cradle of, for example, a bicycle or motorcycle, thereby reducing the chance that the device may be forgotten in the charging cradle when the bicycle or motorcycle is stopped, and thereby helping to avoid loss or theft of the device.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A portable electronic device, comprising:
a controller configured to execute instructions;
a memory coupled to the controller and configured to store instruction modules;
a power source coupled to the controller and configured to be rechargeable;
an alarm coupled to the controller;
a charging port coupled to the controller and configured to be identifiably coupled to a predetermined type of charger, the charging port further configured to receive charge to recharge the power source;
a charger detection module having instructions configured to detect and identify when the portable electronic device is coupled to the predetermined type of charger;
a charger voltage monitoring module having instructions configured to monitor whether an applied voltage of the received charge is below a predetermined threshold value;
an alarm activation module having instructions configured to activate the alarm after a predetermined time when the charger detection module detects and identifies the predetermined type of charger and the charger voltage monitoring module detects that the applied voltage is below the predetermined threshold value.

2. The portable electronic device of claim 1, wherein the charger detection module is configured to detect and identify a charger based on detection of a predetermined charger attribute.

3. The portable electronic device of claim 2, wherein detection of a predetermined charger attribute comprises detection of a predetermined charger ID resistor.

4. The portable electronic device of claim 1, wherein the alarm activation module is further configured to cease activation of the alarm after a predetermined time.

5. The portable electronic device of claim 1, further comprising:
a user input device configured to accept user input;
wherein the alarm activation module is further configured to cease activation of the alarm when particular user input to the user input device is detected.

6. The portable electronic device of claim 1, further comprising:
a user input device configured to accept user input;
wherein the alarm activation module is further configured to continue the alarm until entry of a predetermined security code is detected by the user input device.

7. The portable electronic device of claim 1, wherein the alarm is at least one of an audible alarm and a visible alarm.

8. A mobile communication device, comprising:
a controller configured to execute instructions;
a memory coupled to the controller and configured to store instruction modules;
a power source coupled to the controller and configured to be rechargeable;
an audio transducer coupled to the controller, the audio transducer configured to emit an alert signal having a volume below a first predetermined volume and configured to emit a alarm having a volume above a second predetermined volume;
a charging port coupled to the controller and configured to be coupled to an identifiable type of charger, the charging port further configured to receive charge to recharge the power source;
a charger detection module having instructions configured to detect a type of charger;
a charger voltage monitoring module having instructions configured to monitor whether an applied voltage of the received charge is below a predetermined threshold value;
an alert module having instructions configured to start an alert timer for a predetermined alert time and to transmit a signal to the audio transducer to emit the alert signal for the predetermined alert time, when the charger detection module detects a type of charger and the charger voltage monitoring module detects that the applied voltage is below the predetermined threshold value; and
an alarm activation module having instructions configured to transmit a signal to the audio transducer to emit an alarm having a volume above the second predetermined volume after the predetermined alert time has expired, and the charger detection module detects the type of charger and the charger voltage monitoring module detects that the applied voltage is below the predetermined threshold value.

9. The mobile communication device of claim 8, further comprising:
an alarm inactivation module having instructions configured to extinguish the alarm when the charger detection module no longer detects a type of charger.

10. The mobile communication device of claim 8, wherein the charger detection module is configured to detect a charger based on detection of a predetermined charger attribute.

11. The mobile communication device of claim 10, wherein detection of a predetermined charger attribute comprises detection of a predetermined charger ID resistor.

12. The mobile communication device of claim 8, wherein the charger detection module is configured to detect a bicycle charger based on detection of a predetermined charger attribute.

13. The mobile communication device of claim 8, further comprising:
a user input device configured to accept user input;
wherein the alarm activation module is further configured to cease activation of the alarm when particular user input to the user input device is detected.

14. The mobile communication device of claim 8, further comprising:
a visible alarm coupled to the controller and configured to emit a visual indication when the charger detection module detects a type of charger and the charger voltage monitoring module detects that the applied voltage is below the predetermined threshold value.

15. A method of an electronic device having a rechargeable power source, the method comprising:
detecting that the device is attached to a type of charger;
receiving charge from the charger to charge the rechargeable power source of the device;
detecting that an applied voltage of the received charge is below a predetermined threshold;
starting an alert timer for a predetermined alert time;
emitting an alert signal having a volume below a first predetermined volume for the predetermined alert time;
determining, when the alert timer expires, whether the applied voltage is above the predetermined threshold;
emitting an alarm having a volume above a second predetermined volume if the applied voltage is below the predetermined threshold when the alert timer expires; and
ceasing the alarm when the device detects that the device is no longer attached to a type of charger.

16. The method of claim 15, wherein the device has a user input device configured to accept user input, the method further comprising:
ceasing the alert signal when a particular user input is detected.

17. The method of claim 15, wherein the device has a user input device configured to accept user input, the method further comprising:
ceasing the alarm when a particular user input is detected.

18. The method of claim 15, further comprising:
ceasing the alarm after a predetermined alarm time.

19. The method of claim 15, further comprising:
increasing a volume of the alert signal after a predetermined time interval.

20. The method of claim 15, further comprising:
emitting a visual indication when the applied voltage is below the predetermined threshold value.
